(19) United States
(12) Patent Application Publication
(10) Pub. No.: US 2011/0246355 A1
(43) Pub. Date: Oct. 6, 2011

(54) OVER LIMIT PROTECTION

(75) Inventors: Maura L. Griffin, Atlanta, GA (US); Harry Guiton Lomax, Charlotte, NC (US)

(73) Assignee: BANK OF AMERICA CORPORATION, Charlotte, NC (US)

(21) Appl. No.: 12/752,251

(22) Filed: Apr. 1, 2010

(51) Int. Cl. G06Q 40/00

(52) U.S. Cl. 705/38; 705/44

(57) ABSTRACT

In general terms, embodiments of the present invention relate to methods and apparatuses for providing over limit protection and/or for determining authorization decisions for over limit transactions. For example, some embodiments of the present invention are configured to: (a) receive a request to authorize a transaction involving a credit account, (b) determine that the credit account will incur an overage as a result of the transaction, and (c) authorize the transaction based at least partially on a determination that the credit account has over limit protection through a source account. As another example, other embodiments of the present invention are additionally or alternatively configured to: (a) determine that a credit account has incurred, or will incur, an overage as a result of a transaction, and (b) transfer funds from a source account to the credit account in an amount sufficient to offset the overage.

### FIELD

In general terms, embodiments of the present invention relate to methods and apparatuses for providing over limit protection.

### BACKGROUND

Financial institution customers are constantly looking for new and useful ways to protect themselves against the consequences of occasionally exceeding credit limits and/or accidentally making financial mistakes. This is particularly so given that most of today's financial institution customers have several different financial accounts, and the consequences associated with, for example, forgetting to transfer funds, missing an account payment, overdrafting an account, spending beyond a credit limit, etc., can result in serious penalties, such as, for example, substantial fees, interest rate increases, lower credit scores, and/or the like. In some cases, the less tangible consequences associated with these actions are just as bad. For example, it can be embarrassing and/or frustrating to be involved in a transaction that is declined due to non-sufficient funds or unavailable credit. Accordingly, there is a need to provide methods and apparatuses that help financial institution customers mitigate and/or avoid the consequences associated with occasionally exceeding credit limits and/or accidentally making financial mistakes.

### SUMMARY OF SELECTED EMBODIMENTS OF THE PRESENT INVENTION

In general terms, embodiments of the present invention relate to methods and apparatuses for providing over limit protection. For example, some embodiments of the present invention are embodied as an apparatus that includes: (a) a communication interface configured to receive a request to authorize a transaction involving a credit account; and (b) a processor operatively connected to the communication interface and configured to: (i) determine that the credit account will incur an overage as a result of the transaction; and (ii) authorize the transaction based at least partially on a determination that the credit account has over limit protection through a source account.

In some embodiments of the apparatus, the overage includes the difference between an amount of one or more liabilities incurred by the credit account as a result of the transaction and an amount of credit available to the credit account immediately prior to the transaction. In some embodiments, the source account includes two or more source accounts, and the processor is configured to transfer funds from the two or more source accounts to the credit account in accordance with one or more user selections. In some embodiments of the apparatus, the processor is also configured to transfer funds from the source account to the credit account in an amount sufficient to offset the overage. For example, in some embodiments, the processor is configured to transfer offsetting funds from the source account to the credit account before the overage is charged to the credit account.

In some embodiments of the apparatus, the processor is configured to authorize the transaction based at least partially on: (a) the determination that the credit account has over limit protection through the source account, and (b) a determination that the source account includes sufficient funds to offset the overage. In other embodiments, the processor is configured to authorize the transaction based at least partially on: (a) the determination that the credit account has over limit protection through the source account, (b) a determination that the source account includes insufficient funds to offset the overage, and (c) a determination that a holder of the credit account has opted in to an over limit service provided by a creditor associated with the credit account. In some embodiments, the determination that the holder of the credit account has opted in to the over limit service is based at least partially on the determination that the credit account has over limit protection through the source account. Further, in some embodiments of the apparatus, the over limit service is provided in accordance with the Credit CARD Act of 2009.

In some embodiments of the apparatus, the processor is further configured to charge a service fee to at least one of the source account or the credit account. In some embodiments, the processor is configured to authorize the transaction based at least partially on: (a) the determination that the credit account has over limit protection through the source account, and (b) a determination that the amount of the overage is less than a predetermined amount. In still other embodiments of the apparatus, the communication interface is configured to receive a second request to authorize a second transaction involving a second credit account, and the processor is configured to: (a) determine that the second credit account will incur a second overage as a result of the second transaction; and (b) decline the second transaction based at least partially on: (i) a determination that the second credit account has over limit protection through a second source account, (ii) a determination that the second source account includes insufficient funds to offset the second overage, and (iii) a determination that a second holder of the second credit account has not opted in to an over limit service provided by a second creditor associated with the second credit account.

In some embodiments of the apparatus, the communication interface is further configured to receive a second request to authorize a second transaction involving a second credit account, and where the processor is further configured to: (a) determine that the second credit account will incur a second overage as a result of the second transaction; (b) determine that the second credit account has over limit protection through a second source account; and (c) decline the second transaction based at least partially on at least one of: (i) a determination that the amount of the second overage is greater than a predetermined amount, or (ii) a determination that the second transaction occurs outside of a predetermined geographic area. In some embodiments, the processor is configured to decline the second transaction based at least partially on a user-selected parameter. In some embodiments of the apparatus, the processor is configured to generate a notification regarding the overage, the communication device is configured to transmit the notification to a device accessible to the consumer while the transaction is still pending, the communication device is configured to receive a response to the notification, and the processor is configured to authorize the transaction based at least partially on the response.

As another example, some embodiments of the present invention are embodied as a method that includes: (a) receiving a request to authorize a transaction involving a credit account; (b) determining that the credit account will incur an overage as a result of the transaction; and (c) authorizing, using a processor, the transaction based at least partially on a determination that the credit account has over limit protection through a source account.

As still another example, some embodiments of the present invention are embodied as an apparatus that includes: (a) a communication interface configured to receive requests to authorize transactions, where each of the transactions involves a credit account that will incur an overage if the transaction is authorized; and (b) a processor operatively connected to the communication interface and configured to: (i) authorize a first group of the transactions based at least partially on a determination that, for each transaction in the first group, the credit account has over limit protection through a source account; (ii) authorize a second group of the transactions based at least partially on a determination that, for each transaction in the second group, the credit account is held by a holder that has opted in to an over limit service provided by a creditor associated with the credit account; and (iii) decline a third group of the transactions based at least partially on: (A) a determination that, for each transaction in the third group, the credit account does not have over limit protection through a source account, and (B) a determination that, for each transaction in the third group, the credit account is held by a holder that has not opted in to an over limit service provided by a creditor associated with the credit account.

In some embodiments of this apparatus, the processor is also configured to, for each transaction in the first group, transfer funds from the source account to the credit account in an amount sufficient to offset the overage. In some embodiments, the processor is additionally or alternatively configured to: (a) for each transaction in the first group, charge an over limit protection fee to at least one of the source account or the credit account; and (b) for each transaction in the second group, charge an overage fee to the credit account, where the overage fee is greater than the over limit protection fee.

In some embodiments of the apparatus, the processor is configured to authorize the first group of the transactions based at least partially on: (a) the determination that, for each transaction in the first group, the credit account has over limit protection through a source account, and (b) a determination that, for each transaction in the first group, the source account includes sufficient funds to offset the overage. In some embodiments, the processor is configured to authorize the second group of the transactions based at least partially on: (a) the determination that, for each transaction in the second group, the credit account is held by a holder that has opted in to an over limit service provided by a creditor associated with the credit account, (b) a determination that, for each transaction in the second group, the credit account has over limit protection through a source account, and (c) a determination that, for each transaction in the second group, the source account includes insufficient funds to offset the overage.

In some embodiments, the determination that, for each transaction in the second group, the credit account is held by a holder that has opted in to a over limit service is based at least partially on the determination that, for each transaction in the second group, the credit account has over limit protection through a source account. In some embodiments of the apparatus, the over limit service is provided in accordance with the Credit CARD Act of 2009. Also, in some embodiments of the apparatus, the processor is further configured to decline a fourth group of the transactions based at least partially on: (a) a determination that, for each transaction in the fourth group, the credit account has over limit protection through a source account, (b) a determination that, for each transaction in the fourth group, the source account includes insufficient funds to offset the overage, and (c) a determination that, for each transaction in the fourth group, the credit account is held by a holder that has not opted in to an over limit service provided by a creditor associated with the credit account.

As yet another example, some embodiments of the present invention are embodied as a method that includes: (a) receiving requests to authorize transactions, where each of the transactions involves a credit account that will incur an overage if the transaction is authorized; (b) authorizing, using a processor, a first group of the transactions based at least partially on a determination that, for each transaction in the first group, the credit account has over limit protection through a source account; (c) authorizing, using a processor, a second group of the transactions based at least partially on a determination that, for each transaction in the second group, the credit account is held by a holder that has opted in to an over limit service provided by a creditor associated with the credit account; and (d) declining, using a processor, a third group of the transactions based at least partially on: (i) a determination that, for each transaction in the third group, the credit account does not have over limit protection through a source account, and (ii) a determination that, for each transaction in the third group, the credit account is held by a holder that has not opted in to an over limit service provided by a creditor associated with the credit account.

As another example, some embodiments of the present invention are embodied as a computer program product that includes a non-transitory computer-readable medium having computer-executable program code portions stored therein. In some embodiments, the computer-executable program code portions include: (a) a first program code portion configured to receive requests to authorize transactions, where each of the transactions involves a credit account that will incur an overage if the transaction is authorized; (b) a second program code portion configured to authorize a first group of the transactions based at least partially on a determination that, for each transaction in the first group, the credit account has over limit protection through a source account; (c) a third program code portion configured to authorize a second group of the transactions based at least partially on a determination that, for each transaction in the second group, the credit account is held by a holder that has opted in to an over limit service provided by a creditor associated with the credit account; and (d) a fourth program code portion configured to decline a third group of the transactions based at least partially on a determination that, for each transaction in the third group, the credit account: (i) does not have over limit protection through a source account, and (ii) is held by a holder that has not opted in to an over limit service provided by a creditor associated with the credit account.

As still another example, some embodiments of the present invention are embodied as an apparatus that includes a processor configured to: (a) determine that a credit account has incurred, or will incur, an overage as a result of a transaction; and (b) transfer funds from a source account to the credit account in an amount sufficient to offset the overage.

As a further example, some embodiments of the present invention are embodied as a method that includes: (a) determining that a credit account has incurred, or will incur, an overage as a result of a transaction; and (b) transferring funds, using a processor, from a source account to the credit account in an amount sufficient to offset the overage.

### BRIEF DESCRIPTION OF THE DRAWINGS

Having thus described embodiments of the present invention in general terms, reference will now be made to the accompanying drawings, wherein:

FIG. 1 is a flow diagram illustrating a general process flow of an apparatus for providing over limit protection, in accordance with an embodiment of the present invention;

FIG. 2 is a flow diagram illustrating a general process flow of an apparatus for providing over limit protection, in accordance with an embodiment of the present invention;

FIG. 3 is a flow diagram illustrating a more-detailed process flow of an apparatus for providing over limit protection for a credit card account, in accordance with an embodiment of the present invention;

FIG. 4 is a block diagram illustrating technical components of a system for providing over limit protection, in accordance with an embodiment of the present invention; and

FIG. 5 is a mixed block and flow diagram of a system for providing over limit protection, in accordance with an embodiment of the present invention.

### DETAILED DESCRIPTION OF EMBODIMENTS OF THE PRESENT INVENTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and/or vice versa, unless explicitly stated otherwise. Also, as used herein, the term “a” and/or “an” shall mean “one or more,” even though the phrase “one or more” is also used herein. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory and/or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

Further, although many of the embodiments of the present invention described herein are generally described as involving a “financial institution,” other embodiments of the present invention may involve one or more persons, organizations, businesses, and/or other entities that take the place of, and/or work in conjunction with, the financial institution to implement one or more portions of one or more of the embodiments described and/or contemplated herein.

It will be understood that the term “overage,” as used herein, generally refers to the difference between: (a) the total amount of one or more purchases, draws, fees, charges, balance transfers, and/or other debt obligations (collectively referred to herein as “liabilities” for simplicity) incurred, or that will be incurred, by a credit account as a result of a transaction, and (b) the amount of credit available to the credit account immediately prior to the transaction. For example, if a credit account has $500 in available credit immediately before the credit account is used to make a $600 purchase, then it will be understood that the credit account will incur an overage in the amount of $100 as a result of the purchase. Additionally or alternatively, in some embodiments, the term “overage” generally refers to the difference between an account balance for the credit account and a credit limit (sometimes referred to as “credit line”) associated with the credit account. For example, if a credit account has a $5,000 credit limit and a $5,300 account balance, then it will be understood that the credit account has incurred one or more overages totaling $300.

It will also be understood that the phrase “over limit transaction,” as used herein, generally refers to any past, present, future, initiated, pending, and/or completed transaction involving a credit account that results in the credit account incurring an overage. The term “transaction,” as used herein, generally refers to an event involving a purchase, fee, charge, draw, balance transfer, exchange, and/or the like. It will also be understood that the phrase “over limit protection,” as used herein, generally refers to the concept of using funds from a financial account (referred to herein as a “source” account) to offset (e.g., sweep, pay off, prepay, cover, cancel out, negate, make up for, etc.) one or more overages incurred, and/or that will be incurred, by a credit account as a result of one or more over limit transactions. In such cases, it will be understood that the source account provides over limit protection to the credit account, or in other words, the credit account has over limit protection through the source account.

In general terms, embodiments of the present invention relate to methods and apparatuses for providing over limit protection. For example, some embodiments of the present invention are configured to: (a) determine that a credit account has incurred, or will incur, an overage as a result of a transaction; and (b) transfer funds from a source account to the credit account in an amount sufficient to offset the overage. As another example, some embodiments of the present invention are additionally or alternatively configured to: (a) receive a request to authorize a transaction involving a credit account, (b) determine that the credit account will incur an overage as a result of the transaction; and (c) authorize the transaction based at least partially on a determination that the credit account has over limit protection through a source account.

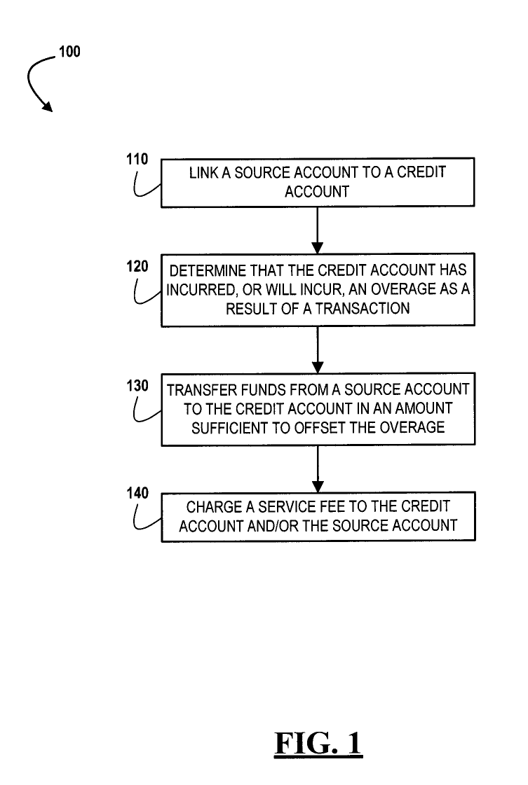

Referring now to FIG. 1, a general process flow 100 of an apparatus for providing over limit protection is provided, in accordance with an embodiment of the present invention. As represented by the block 110, the apparatus is configured to link a source account to a credit account. As represented by the block 120, the apparatus is also configured to determine that the credit account has incurred, or will incur, an overage as a result of a transaction (sometimes, for simplicity, collectively referred to herein as “making an overage determination”). As represented by the block 130, the apparatus is also configured to transfer funds from the source account to the credit account in an amount sufficient to offset the overage (sometimes, for simplicity, collectively referred to herein as “making an offsetting funds transfer” and/or “transferring offsetting funds”). As represented by the block 140, in some embodiments, the apparatus is further configured to charge a service fee to the credit account and/or to the source account.

Regarding the block 110, it will be understood that the apparatus can be configured to link the source account to the credit account in any way. For example, in some embodiments, the source account is linked to the credit account by electronically and/or communicably connecting the source account to the credit account, such that, for example, funds in the source account may be transferred to the credit account and/or vice versa. In some embodiments, by linking the source account to the credit account, the apparatus having the process flow 100 configures the source account to automatically offset one or more overages incurred, and/or that will be incurred, by the credit account.

It will also be understood that the source account referred to in the process flow 100 can include any type of financial account. For example, in some embodiments, the source account includes a deposit account, credit account, investment account, checking account, savings account, money market account, certificate of deposit account, credit card account, line of credit (LOC) account, home equity line of credit (HELOC) account, brokerage account, margin account, sweep account, store credit account, and/or any other type of financial account. It will further be understood that the credit account referred to in the process flow 100 can include any type of credit account. For example, in some embodiments, the credit account includes a credit card account, LOC account, HELOC account, store credit account, and/or any other type of credit account. In some embodiments, the source account and the credit account both include credit accounts, such as, for example, where the source account and the credit account are both credit card accounts, where the source account is a HELOC account and the credit account is a credit card account, and/or the like.

It will also be understood that the source account and the credit account can each include any number of accounts. For example, in some embodiments, the credit account is a credit card account, and the source account includes a checking account and a savings account, such that both the checking account and the savings account are linked to the credit account and are configured to offset one or more overages incurred, and/or that will be incurred, by the credit account. As another example, in some embodiments, the source account is a checking account, and the credit account includes a credit card account and a HELOC account, such that the checking account is linked to both the credit card account and the HELOC account and is configured to offset one or more overages incurred, and/or that will be incurred, by the credit card account and/or by the HELOC account.

It will also be understood that the source account and the credit account may be determined, identified, inputted, defined, and/or otherwise selected (collectively referred to herein as “selected” or “select” for simplicity) for linking in any way. For example, in some embodiments, the apparatus having the process flow 100 is configured to prompt and/or enable a user (e.g., a holder of the source account and/or the credit account, a financial institution employee, etc.) to select, e.g., via the customer's online and/or mobile banking account, the source account and the credit account for linking Also, in some embodiments, the apparatus having the process flow 100 is configured to determine, and/or recommend to a user, the source account and the credit account for linking. For example, in some embodiments, the apparatus is configured to access a financial institution customer's online and/or mobile banking account to determine the number and types of accounts held by the customer, how frequently those accounts are used (e.g., by analyzing the transaction history of those accounts), how well those accounts are funded, etc., and then based at least partially on that information, automatically select two or more accounts for linking and/or recommend to the customer which accounts the customer should select for linking.

Further, it will be understood that, in some embodiments, the source account, the credit account, and/or the apparatus having the process flow 100 are controlled, serviced, managed, operated, and/or maintained (collectively referred to herein as “maintained” for simplicity) by a single financial institution. For example, in some embodiments, the apparatus is maintained by a bank, the source account is maintained by the bank, the credit account is maintained by the bank, and the apparatus is configured to link the source account to the credit account. Of course, in accordance with some embodiments, the source account and the credit account need not be maintained by the same financial institution (or any financial institution). For example, in some embodiments, the apparatus having the process flow 100 is configured to enable over limit protection involving a checking account maintained by Financial Institution A and a credit card account maintained by Financial Institution B.

Additionally, it will be understood that, in some embodiments, the source account and the credit account are held by the same account holder (e.g., the same individual, the same business, etc.), but that in other embodiments, the source account and the credit account are held by different account holders (e.g., different individuals, different businesses, etc.). Also, it will be understood that, although much of the description herein refers to accounts held by individuals, the source account and/or the credit account may be held by one or more families, households, social networks, businesses (e.g., corporations, business units within corporations, small businesses, for-profit, non-profit, etc.), and/or other entities. For example, in some embodiments, the source account is a family checking account, and the credit account is a family credit card account, where each account is jointly held by husband and wife. As another example, in some embodiments, the source account is a small business checking account, and the credit account is a small business LOC account. Of course, it will be understood that some embodiments of the present invention may involve at least two different types of entities, such as, for example, where the source account is an individual's checking account and the credit account is a family or business credit card account.

Regarding the block 120, it will be understood that the transaction referred to in the process flow 100 can include any over limit transaction, i.e. any past, present, future, initiated, pending, completed, etc. transaction involving a credit account that results in the credit account incurring an overage. Thus, in some embodiments, the apparatus having the process flow 100 is configured to determine that a credit account has incurred an overage as a result of a past and/or completed transaction (e.g., a transaction that has already occurred, been processed, been posted, etc.). For example, in some embodiments, the apparatus is configured to determine that a credit account has incurred an overage based at least partially on receiving, analyzing, etc. information associated with the transaction history of the credit account. Examples of transaction history information include, but are not limited to, information normally found in a credit account statement, such as, for example, purchase/draw amounts, descriptions of goods/services purchased, transaction dates, monthly charges, merchant and/or counterparty names, descriptions of fees and/or other charges, etc.

In other embodiments, the apparatus having the process flow 100 is additionally or alternatively configured to determine that a credit account will incur an overage as a result of a present, future, initiated, and/or pending transaction (e.g., a transaction that has not yet occurred but will, etc.). For example, in some embodiments, the apparatus is configured to determine that a credit account will incur an overage as a result of a transaction based at least partially on a determination that the transaction has been initiated (e.g., at a point of sale device, etc.) and/or has been authorized (e.g., by the apparatus having the process flow 100, by another apparatus, etc.), but has not yet been completed.

In addition to the above examples, it will also be understood that the apparatus having the process flow 100 can be configured to determine that a credit account has incurred, or will incur, an overage as a result of a transaction in any way. For example, in some embodiments, the apparatus is embodied as a financial transaction processing apparatus that is configured to process financial transactions involving the source account and/or credit account. In some of these embodiments, the apparatus having the process flow 100 is configured to make overage determinations for the credit account at the same time as, and/or nearly the same time as, the apparatus is processing transactions involving the credit account. As still another example, in some embodiments, the apparatus having the process flow 100 is embodied as an authorization apparatus configured to authorize, decline, and/or determine some other authorization decision for one or more over limit transactions and/or other transactions involving the credit account.

It will also be understood that the apparatus having the process flow 100 can be configured to make overage determinations in real time, in substantially real time, and/or at one or more predetermined times. For example, in some embodiments, the apparatus is configured to make overage determinations continuously, such that the apparatus can identify an overage immediately or nearly immediately after the overage is incurred (e.g., upon the swipe of a credit card, etc.). As another example, in some embodiments, the apparatus is configured to make overage determinations at a specific time during the day, such as, for example, at the end of day, at mid day, at the beginning of day, at 12:45 pm, etc. In other embodiments, the apparatus is configured to make overage determinations at the end of every week, at the end of the month, just after an account statement is ready, just before a payment due date, when one or more transactions post, and/or at one or more other predetermined times.

Regarding the block 130, by the term “offset,” it is meant that the total amount of funds transferred from the source account to the credit account at least equals the total amount of the overage incurred, or that will be incurred, by the credit account as the result of the transaction. For example, in some embodiments, where the credit account has incurred, or will incur, an overage in the amount of $200 as a result of a transaction, the apparatus having the process flow 100 is configured to transfer exactly $200 in funds from the source account to the credit account. However, in other embodiments, where the credit account has incurred, or will incur, an overage in the amount of $200 as a result of a transaction, the apparatus having the process flow 100 is configured to transfer more than $200 in funds from the source account to the credit account. For example, in some embodiments, in addition to making the offsetting funds transfer, the apparatus is configured to charge a service fee to the credit account for incurring the overage and/or making the offsetting funds transfer. In some of these embodiments, the apparatus is further configured to transfer funds from the source account to the credit account in an amount sufficient to offset the amount of the service fee, thereby preventing the service fee from triggering a subsequent overage and/or a subsequent service fee. As another example, in some embodiments, the apparatus having the process flow 100 is configured to transfer offsetting funds in set increments, such as, for example, in increments of $5, $25, $100, and/or the like. Thus, it will be understood that the apparatus having the process flow 100 can be configured to transfer offsetting funds in an amount equal to and/or greater than the amount of the overage. Of course, in embodiments where the source account is made up of a number of different accounts, the amount transferred from each source account may be less than the amount of the overage, but the sum of the amounts transferred will be greater than or equal to the amount of the overage.

It will also be understood that the apparatus having the process flow 100 can be configured to make offsetting funds transfers in any way. For example, in some embodiments, the apparatus is configured to electronically wire offsetting funds (e.g., cash, credit, etc.) from the source account to the credit account. In some embodiments, the apparatus is configured to transfer offsetting funds within the same financial institution and/or across one or more different financial institutions. In accordance with some embodiments, the apparatus is configured to perform one or more offsetting funds transfers via batch processing and/or via the Automated Clearing House (ACH) network. As another example, where the source account includes an investment account, in accordance with some embodiments, the apparatus is configured to liquidate one or more investments in the investment account in order to be able to transfer funds from the investment account to the credit account in an amount sufficient to offset the overage (and/or offset a related service fee). It will be understood that, in some embodiments where the source account includes a deposit account and the offsetting funds transfer is not made simultaneously with the overage determination, the apparatus can be configured to place a hold on funds in the source account in an amount sufficient to offset the overage. Similarly, in some embodiments where the source account includes a credit account and the offsetting funds transfer is not made simultaneously with the overage determination, the apparatus can be configured to reduce the amount of credit available to the source account by an amount sufficient to offset the overage.

It will also be understood that the apparatus having the process flow 100 can be configured to make offsetting funds transfers at any time. In some embodiments, the apparatus is configured to make an offsetting funds transfer before the credit account incurs the one or more liabilities associated with the overage, thereby actually preventing the credit account from incurring the overage at all. For example, if the credit account has $50 in available credit immediately before the credit account is used to make a $100 purchase, but the credit account is not charged with the $100 purchase until after the apparatus having the process flow 100 transfers $75 in offsetting funds from the source account to the credit account, then it will be understood that, when the credit account is charged with the purchase, the credit account will have sufficient available credit to cover the purchase (i.e., $50+$75=$125→$125−$100=$25). Of course, it will be understood that, in other embodiments, the apparatus having the process flow 100 can be configured to make the offsetting funds transfer substantially simultaneous with or after the credit account incurs the overage (and/or the one or more liabilities associated with the overage).

In some embodiments, the apparatus having the process flow 100 is configured to make an offsetting funds transfer at the end of the day in which the apparatus determines that the over limit transaction has been authorized (which may or may not be the same day in which the over limit transaction was actually authorized). As another example, in accordance with some embodiments, the apparatus having the process flow 100 is configured to make an offsetting funds transfer upon or after the transaction is initiated, while the transaction is pending, upon or after the transaction is completed, and/or upon or after the transaction posts to the credit account. As a further example, in some embodiments, the apparatus is configured to make an offsetting funds transfer at a predetermined time (e.g., apparatus-selected time, user-selected time, at the end of day in which the transaction was completed, etc.).

It will further be understood that the apparatus having the process flow 100 can be configured to transfer offsetting funds (and/or implement any one or more of the other portions of the process flow 100 represented by the blocks 110-140) upon or after one or more triggering events. As used herein, it will be understood that a “triggering event” refers to an event that automatically triggers the execution, performance, and/or implementation of a triggered action, either immediately, nearly immediately, or sometime after (e.g., within the same day or week or month, at a predetermined time, etc.) the occurrence of the triggering event. For example, in some embodiments, the apparatus having the process flow 100 is configured such that the apparatus making an overage determination (the triggering event) automatically triggers the apparatus to make the offsetting funds transfer (the triggered action). In some embodiments, the apparatus may be additionally configured to automatically transfer the offsetting funds immediately or nearly immediately after making the overage determination. However, in other embodiments, instead of immediately or nearly immediately after making the overage determination, the apparatus is configured to automatically transfer the offsetting funds at some predetermined time after making the overage determination (e.g., forty-eight hours after making the overage determination, at the end of day on the Friday after making the overage determination, etc.).

It will be understood that making an offsetting funds transfer can be referred to as “sweeping” one or more overages from a credit account. In addition, making an offsetting funds transfer can be referred to as “paying off” one or more overages incurred by an account. In some cases where the offsetting funds transfer is made before the credit account incurs the one or more overages, the offsetting funds transfer can be referred to as “prepaying” the credit account to accommodate the one or more overages. For simplicity, it will be understood that, as used herein, the meaning of the term “offsetting” also includes the meanings of the terms “sweeping,” “paying off,” and/or “prepaying,” unless explicitly stated otherwise.

Also regarding the block 130, it will be understood that, where the source account and/or the credit account includes two or more accounts, the offsetting funds transfers may be made in any way. For example, in some embodiments, the apparatus having the process flow 100 is configured to transfer funds from a checking account to offset 30% of every overage incurred by a credit card account and funds from a savings account to offset the other 70% of every overage incurred by the credit card account. As another example, in some embodiments, the apparatus is configured to transfer funds from a checking account to offset the entire first overage incurred by a credit card account and transfer funds from a savings account to offset every subsequent overage incurred by the credit card account. As still another example, in some embodiments, the apparatus is configured to transfer funds only from a first checking account to offset overages incurred by a first credit card account, and transfer funds only from a second checking account to offset overages incurred by a second credit card account. In some embodiments, the apparatus having the process flow 100 is configured to determine (and/or prompt a user to select) one or more rules for making an offsetting funds transfer. Specifically, in some embodiments, the apparatus is configured to transfer funds from a source account to a credit account based at least partially on a predetermined (e.g., user-selected, apparatus-selected, etc.) order, sequence, priority, and/or other selection. As an example, in some embodiments, the apparatus is configured to first use a checking account to make offsetting funds transfers, and when the checking account is nearly depleted and/or otherwise reaches a predetermined threshold, use a savings account to make offsetting funds transfers, and so on.

Regarding the block 140, it will be understood that the phrase “service fee,” as used herein, generally refers to any one or more fees associated with linking the source account to the credit account, making the overage determination, and/or transferring offsetting funds. It will also be understood that, in accordance with some embodiments, the apparatus can be configured to charge the service fee to the source account, the credit account, a holder of the source account, a holder of the credit account, and/or to some other entity. It will further be understood that the apparatus having the process flow 100 can be configured to charge the service fee to the credit account and/or to the source account at any time and/or at any frequency (e.g., per day, at the end of day, per over limit transaction, upon authorization of a over limit transaction, at the end of every statement period in which the credit account incurs one or more overages, in advance of a period of time in which the credit account will have over limit protection, etc.).

It will also be understood that the service fee may take any form. For example, in some embodiments, the apparatus having the process flow 100 is configured to charge a service fee having a set amount (e.g., $39 per over limit transaction, $250 for a one year subscription to an over limit protection service, etc.) to the credit account and/or the source account. As another example, in some embodiments, the apparatus is configured to charge a service fee having a proportional amount (e.g., a percentage of an over limit transaction, a percentage of the balance of the source account, etc.) to the credit account and/or to the source account. In some embodiments, the service fee is embodied as something other than a monetary charge. For example, in some embodiments, the service fee includes an increase in an interest rate, a reduction in cash back awards, a reduced credit limit, and/or one or more other changes to one or more features associated with the credit account and/or source account. However, it will be understood that the phrase “service fee,” as used herein, shall not mean no service fee. In other words, when it is said that an apparatus charges a service fee, it will be understood that the apparatus takes some meaningful action towards a financial account, financial account holder, and/or some other entity.

It will be understood that one or more of the portions of the process flow 100 represented by the blocks 110-140 may serve as a triggering event for one or more of the other portions represented by the blocks 110-140. For example, as already mentioned, the apparatus having the process flow 100 can be configured to automatically transfer the offsetting funds immediately, nearly immediately, or sometime after determining that the credit account has incurred, or will incur, the overage as a result of the transaction. As another example, in some embodiments, the apparatus is configured to automatically charge a service fee upon or after transferring the offsetting funds. In some embodiments, a predetermined time and/or the passage of a predetermined period of time may serve to trigger one or more of the portions represented by the blocks 110-140. For example, in some embodiments, the apparatus having the process flow 100 is configured to automatically transfer offsetting funds from the source account to the credit account three days after determining that the credit account has incurred an overage.

Further, it will be understood that the number, order, and/or content of the portions represented by the blocks 110-140 are exemplary and may vary. For example, in some embodiments, the apparatus is configured to omit the service fee portion of the process flow 100 represented by the block 140. As another example, in some embodiments, the apparatus having the process flow 100 is configured to charge the service fee after determining that the credit account has incurred, or will incur, the overage, but before transferring the offsetting funds.

Also, in some embodiments, the apparatus having the process flow 100 is configured to determine whether the source account has sufficient funds (e.g., sufficient cash, sufficient credit, etc.) to offset the overage before making the offsetting funds transfer from the source account to the credit account. It will be understood that these sufficiency determinations can be made in any way, such as, for example, by analyzing the transaction history of the source account. It will also be understood that, in accordance with some embodiments, if the source account does not have sufficient funds to make the offsetting funds transfer, then the apparatus may be configured to decline the transaction, and/or to stop, queue, and/or otherwise prevent the offsetting funds transfer from being made in order to prevent the source account from being overdrafted or incurring an overage.

Alternatively, in embodiments where one or more additional source accounts having sufficient funds are linked to the credit account, the apparatus can be configured to transfer offsetting funds from those one or more additional source accounts instead from the insufficient source account. In some of these embodiments, the apparatus may be configured to follow a particular priority, order, and/or sequence when determining the source account(s) from which to transfer offsetting funds. For example, in some embodiments, the apparatus is configured to offset an overage using the source account with the highest account balance and/or available credit. As another example, in some embodiments, the apparatus is configured to use a preferred account to offset the overage unless and/or until that preferred account does not have sufficient funds to make the offsetting funds transfer.

As still another example, in some alternate embodiments, the apparatus having the process flow 100 is configured to aggregate multiple individual overages before making offsetting funds transfers. For example, suppose a credit card account holder incurs a $10 overage on Monday morning as a result of a first transaction, a $100 overage on Monday afternoon as a result of a second transaction, and a $30 overage on Monday evening as a result of a third transaction. In such a case, the apparatus may be configured to aggregate those individual overages and then transfer funds from the credit card account holder's checking account to the holder's credit card account in an amount sufficient to offset those liabilities. In other words, the apparatus can be configured to make a one-time offsetting funds transfer of $140 at some later time on Monday instead of making three smaller offsetting funds transfers during the day on Monday (as other embodiments of the apparatus are configured to do).

In some embodiments, the triggering event for implementing one or more of the portions represented by the blocks 110-140 includes a predetermined time and/or the passage of a predetermined period of time. Examples of temporal triggering events include, but are not limited to, the end of day on a particular day, the beginning of day on the first and fifteenth of every month, 12:00 pm on the payment due date, 3:00 pm every Tuesday, 11:59 pm on the Monday before the end of the month, after every ten day period, two weeks after the previous payment, two days before a student loan payment is scheduled to be paid using funds from the source account, etc. It will be understood that, in some embodiments, triggering events are scheduled as one-time only events (e.g., at 2:57 pm on Dec. 27, 2009, etc.), but that in other embodiments, triggering events are recurring such that they occur periodically (e.g., after every deposit, every other Monday, at the first of every month, etc.). It will also be understood that the apparatus having the process flow 100 can be configured to determine any number of triggering events, as well as make any number of offsetting funds transfers, such that, in some embodiments, the apparatus is configured to make an offsetting funds transfer as often as every day, upon or after every over limit transaction, and/or even more frequently.

It will be understood that, in some embodiments, the apparatus having the process flow 100 is also configured to implement, communicate with, and/or be otherwise associated with online and/or mobile banking services. For example, in some embodiments, the apparatus having the process flow 100 is also configured to deliver online and/or mobile banking services to one or more online banking customers via one or more online and/or mobile banking accounts. As another example, in some embodiments, one or more portions of an online and/or mobile banking account (e.g., an online banking tool, etc.) are configured to configure and/or trigger the apparatus having the process flow 100 to perform the portions of the process flow 100. In some embodiments, one or more portions of an online and/or mobile banking account are additionally or alternatively configured to configure (and/or facilitate an online banking customer to configure) the apparatus having the process flow 100 and/or the portions of the process flow 100. For example, in some embodiments, an online banking customer may access an online banking tool via an online banking account in order to select which accounts to link, schedule when overage determinations and/or offsetting funds transfers are made, and so on. In some embodiments, the online and/or mobile banking account may additionally or alternatively be configured to receive one or more notifications associated with one or more of the portions of the process flow 100 (e.g., an e-mail message created/sent by the apparatus that confirms that two accounts have been linked, a digital receipt created/sent by the apparatus that has information associated with the offsetting funds transfer, etc.).

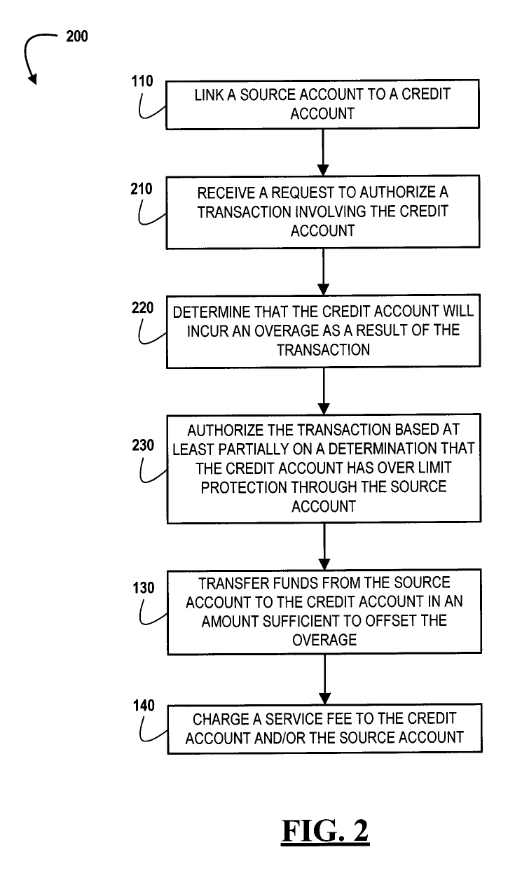

Referring now to FIG. 2, a general process flow 200 is provided as an alternative embodiment to the general process flow 100 illustrated in FIG. 1. As shown in FIG. 2, an apparatus having the process flow 200 is configured to perform generally the same process flow as the process flow 100, except that the apparatus having the process flow 200 is additionally configured to: (a) receive a request to authorize the transaction involving the credit account, as represented by the block 210; (b) determine that the credit account will incur the overage as a result of the transaction, as represented by the block 220; and (c) authorize the transaction based at least partially on a determination that the credit account has over limit protection through the source account, as represented by the block 230.

It will be understood that, in accordance with some embodiments, the apparatus having the process flow 200 is configured to perform one or more portions of the process flow 200 after the transaction has been initiated but before the transaction has been completed (i.e., while the transaction is still pending). It will also be understood that, in accordance with some embodiments, the apparatus is additionally or alternatively configured to perform one or more portions of the process flow 200 in real time and/or near real time (collectively referred to herein as “substantially real time” for simplicity).

For example, in some embodiments, the apparatus having the process flow 200 is maintained by a credit card-issuing bank and is configured to communicate, via a network, with a credit card association (e.g., Visa®, MasterCard®, etc.) and/or an acquiring bank. For example, when a purchase transaction is initiated via an e-commerce web site, by swiping a credit card at a merchant's point of sale (POS) device, and/or the like, the information associated with the purchase transaction is communicated to the merchant's acquiring bank (i.e., the bank that accepts payments for goods and/or services on behalf of the merchant). The acquiring bank then communicates the transaction information to the appropriate credit card association, which routes the transaction information, along with a request to authorize the purchase transaction, to the correct credit card-issuing bank where it is received at the apparatus having the process flow 200 (e.g., because, in some embodiments, the card-issuing bank maintains the apparatus having the process flow 200, etc.). The apparatus then determines an authorization decision (e.g., authorize the transaction, decline the transaction, etc.) and communicates information associated with that authorization decision back to the credit card association and/or the acquiring bank, where it is forwarded to the merchant at the POS device, e-commerce web site, etc., so that the purchase transaction can be completed.

It will be understood that, in accordance with some embodiments, the apparatus having the process flow 200 is configured to execute the entire process flow 200 in substantially real time after the transaction has been initiated and before the transaction has been completed. However, in other embodiments, it will be understood that the apparatus having the process flow 200 is configured to perform the portions represented by the blocks 210-230 after the transaction has been initiated but before the transaction has been completed, and then perform the portions represented by the blocks 130 and 140 after the transaction has been completed.

Regarding the block 230, it will be understood that the apparatus having the process flow 200 can be configured to authorize the transaction based at least partially on one or more determinations other than the determination that the credit account has over limit protection through the source account. For example, in some embodiments, the apparatus is additionally configured to authorize the transaction based at least partially on a determination that the source account has sufficient funds to offset the overage and/or offset a service fee associated with the overage. As another example, in some embodiments, the apparatus is configured to authorize the transaction based at least partially on a determination that the credit account and/or a holder of the credit account has been properly authenticated (e.g., via a username/password, PIN number, expiration date, card code verification (CCV) number, an authentication microchip located in a credit card, etc.).

As still another example, in some embodiments of the present invention, the apparatus having the process flow 200 is additionally or alternatively configured to determine an authorization decision for the over limit transaction based at least partially on one or more user-selected and/or apparatus-selected parameters (collectively referred to herein as “predetermined parameters” for simplicity). For example, in some embodiments, the apparatus is configured to determine an authorization decision for the over limit transaction based at least partially on a determination that the transaction was initiated inside, outside, and/or otherwise relative to one or more predetermined (e.g., user-selected, apparatus-selected, etc.) geographic areas and/or locations (collectively referred to herein as “predetermined geographic areas” for simplicity) in order to, for example, reduce or prevent fraud. As an example, in some embodiments, the apparatus is configured to decline any over limit transaction that occurs outside of the United States. As still another example, in some embodiments, the apparatus is configured to decline any over limit transaction that occurs in a grocery store. As still another example, in some embodiments, the apparatus is configured to authorize every transaction that occurs within ten miles from the holder's residence.

As another example of a predetermined parameter, in some embodiments, the apparatus having the process flow 200 is additionally or alternatively configured to determine an authorization decision for the over limit transaction based at least partially on a determination that the amount of the overage is less than, equal to, greater than, included in, excluded from, and/or otherwise relative to one or more predetermined (e.g., user-selected, apparatus-selected, etc.) overage amounts, ranges, and/or sets. In some embodiments, for example, the apparatus is configured to decline any over limit transaction that will result in the credit account incurring an overage greater than a predetermined amount (e.g., in some embodiments, the “maximum overage amount” is $100, etc.). Other exemplary predetermined parameters include, but are not limited to, the number and/or identity of the parties involved in the transaction, the channel through which the transaction is initiated and/or completed (e.g., POS device, e-commerce web site, etc.), the type of the transaction (e.g., purchase, fee, charge, draw, etc.), the time of the transaction, and/or the like. It will be understood that, in accordance with some embodiments of the present invention, the apparatus having the process flow 200 (and/or any of the other embodiments of the apparatus described and/or contemplated herein) is configured to prompt and/or enable a credit account holder, via, for example, the holder's online and/or mobile banking account, to select and/or set one or more predetermined parameters for providing over limit protection. For example, in some embodiments, the apparatus having the process flow 200 is configured to prompt the credit account holder to select and/or set the maximum overage amount, the predetermined geographic area, and/or the like. As such, it will be understood that, in some embodiments, the “user” is the “holder” and vice versa.

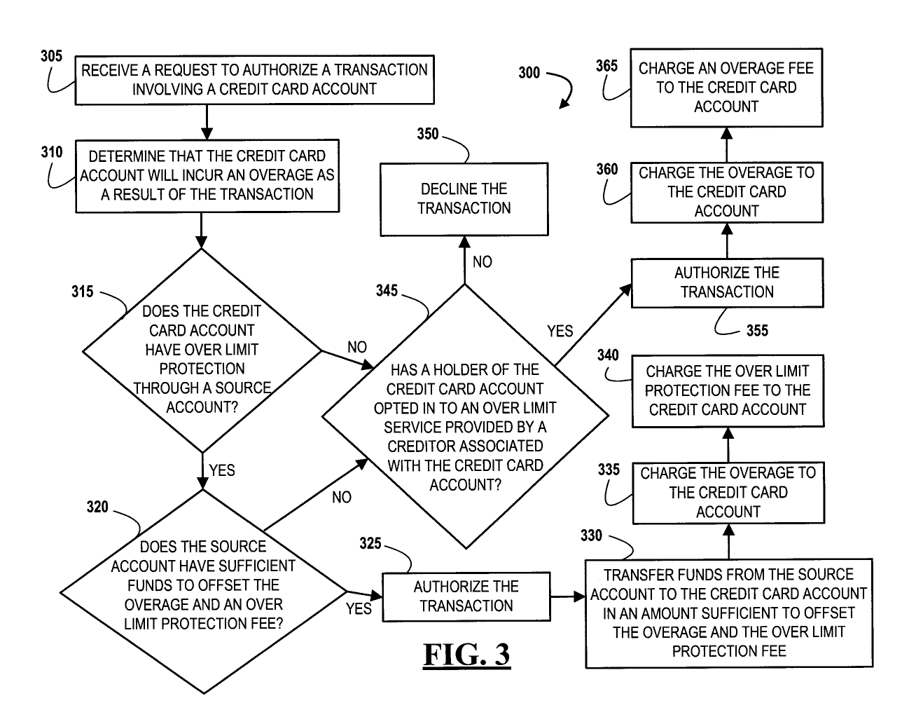

Referring now to FIG. 3, a more-detailed process flow 300 of an apparatus for providing over limit protection for a credit card account is provided, in accordance with an embodiment of the present invention. As represented by the block 305, the apparatus having the process flow 300 is configured to receive a request to authorize a transaction involving the credit card account. As represented by the block 310, the apparatus is configured to determine that the credit card account will incur an overage as a result of the transaction. As represented by the block 315, the apparatus is also configured to determine whether the credit card account has over limit protection through a source account. If yes, then, as represented by the block 320, the apparatus is configured to determine whether the source account has sufficient funds to offset the overage and to offset an over limit protection fee (e.g., a service fee associated with over limit protection, such as, for example, a service fee associated with making an offsetting funds transfer, etc.). If yes, then the apparatus having the process flow 300 is configured to authorize the transaction, as represented by the block 325, and transfer funds from the source account to the credit card account in an amount sufficient to offset the overage and offset the over limit protection fee, as represented by the block 330. After transferring the offsetting funds, the apparatus is configured to charge the overage to the credit card account, as represented by the block 335, and charge the over limit protection fee to the credit card account, as represented by the block 340. Of course, it will be understood that any of these portions of the process flow 300 can be executed in accordance with any one or more of the embodiments described and/or contemplated herein.

However, if the apparatus having the process flow 300 determines that the source account does not have sufficient funds to offset the overage and/or the over limit protection fee, or if the apparatus determines that the credit card account does not have over limit protection through a source account, then the apparatus is configured to determine, as represented by the block 345, whether a holder of the credit card account has “opted in” to an “over limit service” provided by a creditor associated with the credit card account (e.g., a credit card-issuing bank that maintains the credit card account, etc.). In other words, the apparatus having the process flow 300 is configured to determine, at the block 345, whether the credit card account holder has expressly elected (“opted in”) to permit the creditor associated with the credit card account to: (a) authorize (and/or otherwise complete) one or more over limit transactions involving the credit card account that result in the credit card account incurring one or more overages, and (b) charge one or more overage fees associated with the one or more over limit transactions and/or overages to the credit card account, to the credit card account holder, and/or to some other entity (collectively “the over limit service”). It will be understood that the phrases “opt in” and the “over limit service” referred to herein are each provided in accordance with the Credit Card Accountability Responsibility and Disclosure Act of 2009, which is codified in the United States as Public Law No. 111-24 (sometimes referred to herein, for simplicity, as the “Credit CARD Act of 2009” or the “CARD Act”), and/or in accordance with some other similar law, rule, and/or regulation. The CARD Act states, in relevant part, that:
(k) Opt-in Required for [Over Limit] Transactions if [Overage] Fees Are Imposed.
   (1) In general. In the case of any credit card account under an open end consumer credit plan under which an [overage] fee may be imposed by the creditor for any extension of credit in excess of the amount of credit authorized to be extended under such account, no such fee shall be charged, unless the [credit card account holder] has expressly elected to permit the creditor, with respect to such account, to complete transactions involving the extension of credit under such account in excess of the amount of credit authorized.
      Thus, it will be understood that the CARD Act requires the credit card account holder to opt in to the over limit service described above before the creditor is legally permitted to provide such an over limit service. (It will also be understood that, in accordance with some embodiments of the present invention, the apparatus having the process flow 300 (and/or any of the other embodiments described and/or contemplated herein) is configured to prompt and/or enable the credit card account holder to opt in to the over limit service via, for example, the holder's online and/or mobile banking account.) Accordingly, if the holder has not opted in to the over limit service in accordance with the CARD Act and/or other similar law, rule, and/or regulation, then the apparatus having the process flow 300 is configured to decline the transaction, as represented by the block 350.

On the other hand, if the credit card account holder has opted in to the over limit service in accordance with the CARD Act and/or other similar law, rule, and/or regulation, then the apparatus having the process flow 300 is configured to authorize the transaction, as represented by the block 355. After authorizing the transaction, the apparatus having the process flow 300 is configured to charge the overage to the credit card account, as represented by the block 360, and charge an overage fee to the credit card account, as represented by the block 365. As such, in accordance with some embodiments, the overage fee is “imposed by the creditor for [an] extension of credit in excess of the amount of credit authorized to be extended,” in accordance with the CARD Act.

It will be understood that the phrases “overage fee” and “over limit protection fee” both refer to service fees, which may be, in accordance with some embodiments, similar and/or identical. As such, this difference in phrasing is not necessarily meant to imply a different type and/or amount of service fee. Instead, this phrasing is used herein for simplicity, to help avoid reader confusion, and generally to indicate that the over limit protection fee corresponds to the over limit protection service and that the overage fee corresponds to the over limit service.

Of course, in accordance with some embodiments, the amount of the overage fee referred to in the block 365 is greater than the amount of the over limit protection fee referred to in the blocks 320, 330, and 340. In some cases, this may be to, for example, incentivize the credit card account holder to set up over limit protection through the source account instead of, and/or in addition to, opting in to the over limit service. Also, it will be understood that, in some embodiments, the over limit protection referred to the process flow 300 is a service provided by the same creditor that provides the over limit service referred to in the process flow 300.

It will be understood that the over limit protection fee referred to in blocks 320, 330, 340, and elsewhere herein is not “imposed by the creditor for [an] extension of credit in excess of the amount of credit authorized to be extended,” but rather, is charged to the credit card account (and/or to the source account, other entity, etc.) for using the over limit protection service (e.g., making an offsetting funds transfer, etc.). This is true even where the credit card account is actually extended credit in excess of the amount of credit authorized to be extended, such as, for example, where the offsetting funds transfer is made after the credit card account is charged with the overage and the over limit protection fee. As such, the over limit protection fee referred to herein does not fall within the purview of the CARD Act.

In some embodiments, the over limit protection fee does not fall within the purview of the CARD Act for an additional reason. Specifically, in embodiments where the offsetting funds transfer is made before the credit card account is charged with the over limit protection fee and the overage (e.g., the process flow 300), the credit card account does not incur an overage within the meaning of the CARD Act because the creditor never actually extends the credit card account “credit in excess of the amount of credit authorized to be extended” (e.g., credit beyond the credit limit associated with the credit card account, etc.). Indeed, as represented by the blocks 330-340, the apparatus having the process flow 300 is configured to “prepay” the credit card account with funds from the source account, such that there is sufficient credit available in the credit card account to cover the overage and over limit protection fee when those items are charged to the credit card account. In contrast, as mentioned previously, the overage fee referred to in the block 365 falls squarely within the purview of the CARD Act because it is “imposed by the creditor for [an] extension of credit in excess of the amount of credit authorized to be extended.”

It will be understood that, in accordance with some embodiments, the apparatus having the process flow 300 is configured to authorize the over limit transaction involving the credit card account where: (1) the credit card account has over limit protection through a source account and the source account has sufficient funds to offset the overage and offset an over limit protection fee; (2) the credit card account has over limit protection through a source account, the source account has insufficient funds to offset the overage and/or an over limit protection fee, but the credit card account holder has opted in to an over limit service provided by a creditor associated with the credit card account; or (3) the credit card account does not have over limit protection through a source account, but the credit card account holder has opted in to an over limit service provided by a creditor associated with the credit card account.

On the other hand, it will be understood that, in accordance with some embodiments, the apparatus having the process flow 300 is configured to decline the over limit transaction involving the credit card account where: (1) the credit card account has over limit protection through a source account, the source account has insufficient funds to offset the overage and/or offset an over limit protection fee, and the credit card account holder has not opted in to an over limit service provided by a creditor associated with the credit card account; or (2) the credit card account does not have over limit protection through a source account, and the credit card account holder has not opted in to an over limit service provided by a creditor associated with the credit card account. It will be understood that, in some embodiments, the apparatus having the process flow 300 can be configured to decline the over limit transaction involving the credit card account for one or more additional or alternative reasons, including, for example, where the amount of the overage is greater than a predetermined amount (e.g., the maximum overage amount, etc.), where the over limit transaction occurs outside of a predetermined geographic area (e.g., decline any credit card transaction that occurs in a casino, etc.), and/or the like.

It will be understood that, in other embodiments of the present invention, the apparatus having the process flow 300 can be additionally or alternatively configured to generate and/or transmit a notification to a device accessible to the holder, where the notification: (a) notifies the holder that the credit card account will incur an overage as a result of the transaction, and (b) prompts the holder to authorize the transaction or decline the transaction. It will be understood that the notification may take any form (e.g., email, text message, instant message, phone call, message received via a mobile app located on a mobile phone, message received via an application located on a POS device, etc.), and that the device accessible to the holder may take any form (e.g., mobile phone, pager, personal digital assistant (PDA), personal computer, POS device, etc.). In some embodiments, the notification is generated and/or transmitted in substantially real time, so that, for example, the holder can respond to the prompt while the transaction is still pending. Further, it will be understood that the device to which the notification is communicated, and/or the notification itself, can include functionality (e.g., selectable link, fillable field, email address, phone number, etc.) that enables the holder to respond to the prompt in the notification. Of course, it will be understood that the apparatus can be configured to receive the response to the notification from the holder in any form and via any medium (e.g., email, text message, instant message, phone call, etc.). It will also be understood that, in accordance with some embodiments, the apparatus having the process flow 300 is configured to generate the notification, transmit the notification to the holder, receive the response to the notification from the holder, and authorize or decline the transaction based at least partially on the holder's response, all of which occur sometime after the apparatus determines that the credit card account will incur an overage as a result of the transaction and sometime before the apparatus authorizes or declines the transaction.

In addition to, or instead of, prompting the holder to authorize or decline the transaction, in some embodiments, the notification prompts the user to select one or more source accounts from which to provide funds to offset the overage. For example, in some embodiments, after determining that the credit card account will incur an overage as a result of the transaction and after determining that the credit card account has over limit protection through both a checking account and a savings account, the apparatus having the process flow 300 is configured to prompt the holder to choose how to offset the overage using available funds from the checking account and/or the savings account.

Additionally or alternatively, in some embodiments, the apparatus having the process flow 300 is configured to generate and/or transmit a notification to the holder that prompts the holder to opt-in to an over limit service provided by a creditor associated with the credit card account. In such embodiments, if the credit card account does not have over limit protection through the source account, the holder can respond to the notification to opt-in to the over limit service in order to ensure that the transaction is authorized by the apparatus. As another example, in some embodiments, the apparatus having the process flow 300 is additionally or alternatively configured to generate and/or transmit a notification to the holder that prompts the holder to authorize or decline, for a particular transaction, the use of the over limit protection service and/or the use of the over limit service provided by the creditor associated with the credit card account.

In some embodiments of the present invention, the apparatus having the process flow 300 is additionally or alternatively configured to determine whether the credit card account holder and/or credit card account satisfies one or more credit requirements (e.g., related to the holder's credit score, overage record, etc.) after determining that the holder has opted in to the over limit service and before authorizing the over limit transaction. In such embodiments, if the one or more credit requirements are satisfied, then the apparatus is configured to authorize the transaction; but if they are not, the apparatus is configured to decline the transaction.

Also, in some alternative embodiments, the apparatus is configured to determine that the credit card account holder has opted in to the over limit service provided by the creditor based at least partially on a determination that the credit card account has over limit protection through the source account (which may, in some embodiments, also be provided by the creditor). In other words, in accordance with some embodiments, the credit card account holder can automatically opt in to the over limit service by enrolling in the over limit protection service (i.e., the holder's enrollment in the over limit protection service serves as the holder's opt in to the over limit service). In such embodiments, the apparatus can be configured to transfer the offsetting funds from the source account to the credit card account before, after, or substantially simultaneous with charging the overage and/or the over limit protection fee to the credit card account. Of course, it will further be understood that some alternative embodiments of the process flow 300 involve, where possible, one or more other types of credit accounts instead of, or in addition to, a credit card account.

It will also be understood that, in some embodiments, the apparatus having the process flow 300 is configured to: (a) authorize a transaction that results in an overage; (b) transfer funds from the source account to the credit card account in order to offset part of the overage; and (c) charge the rest of the overage to the credit card account. As such, it will be understood that, for a single transaction, a holder may utilize both the over limit protection service involving the source account and the over limit service requiring the opt-in. This may be useful where the source account does not have sufficient funds to offset the entire overage but does have some funds to offset part of the overage. It will also be understood that, in such embodiments, the credit card account (and/or the source account, the holder, etc.) may incur both an overage fee and an over limit protection fee for that single transaction.

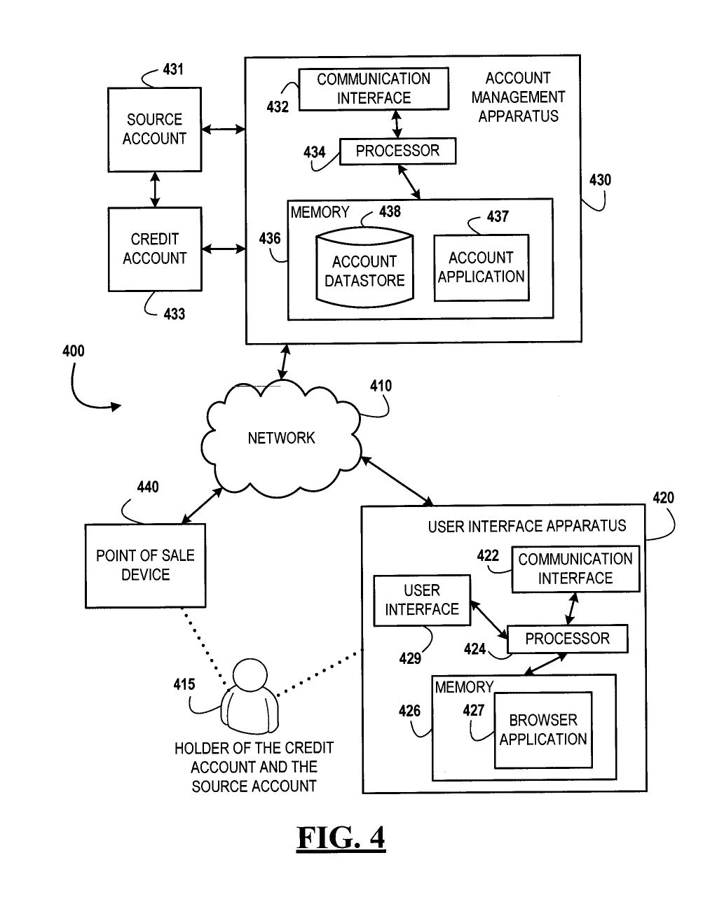

Referring now to FIG. 4, a system 400 for providing over limit protection is provided, in accordance with an embodiment of the present invention. As illustrated, the system 400 includes a network 410, a user interface apparatus 420, an account management apparatus 430, and a point of sale device 440. FIG. 4 also illustrates a source account 431 (e.g., a checking account, savings account, investment account, credit card account, etc.) and a credit account 433 (e.g., a credit card account, LOC account, HELOC account, etc.), both of which are operatively connected (e.g., linked) to the account management apparatus 430, as well as to each other. Also shown in FIG. 4 is the holder 415 of the source account 431 and the credit account 433. It will be understood that the holder 415 has access to the user interface apparatus 420 and the point of sale device 440. In this embodiment, the user interface apparatus 420 is maintained by the holder 415, the point of sale device 440 is maintained by a merchant (not shown), and the account management apparatus 430, along with the credit account 431 and the deposit account 433, are maintained by a single financial institution (not shown) for the benefit of the holder 415. It will also be understood that the holder 415 may use the source account 431 and/or the credit account 433 to make one or more purchases from the merchant by using the point of sale device 440.

As shown in FIG. 4, the user interface apparatus 420, the account management apparatus 430, and the point of sale device 440 are each operatively and selectively connected to the network 410, which may include one or more separate networks. In addition, the network 410 may include a local area network (LAN), a wide area network (WAN), and/or a global area network (GAN), such as the Internet. It will also be understood that the network 410 may be secure and/or unsecure and may also include wireless and/or wireline technology.

The user interface apparatus 420 may include any computerized apparatus that can be configured to perform any one or more of the functions of the user interface apparatus 420 described and/or contemplated herein. In some embodiments, for example, the user interface apparatus 420 may include a personal computer system, a mobile phone, a personal digital assistant, a public kiosk, a network device, and/or the like. As illustrated in FIG. 4, in accordance with some embodiments of the present invention, the user interface apparatus 420 includes a communication interface 422, a processor 424, a memory 426 having a browser application 427 stored therein, and a user interface 429. In such embodiments, the communication interface 422 is operatively and selectively connected to the processor 424, which is operatively and selectively connected to the user interface 429 and the memory 426.

Each communication interface described herein, including the communication interface 422, generally includes hardware, and, in some instances, software, that enables a portion of the system 400, such as the user interface apparatus 420, to transport, send, receive, and/or otherwise communicate information to and/or from the communication interface of one or more other portions of the system 400. For example, the communication interface 422 of the user interface apparatus 420 may include a modem, server, electrical connection, and/or other electronic device that operatively connects the user interface apparatus 420 to another electronic device, such as the electronic devices that make up the account management apparatus 430.

Each processor described herein, including the processor 424, generally includes circuitry for implementing the audio, visual, and/or logic functions of that portion of the system 400. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the browser application 427 of the memory 426 of the user interface apparatus 420.

Each memory device described herein, including the memory 426 for storing the browser application 427 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 426 includes the browser application 427. In some embodiments, the browser application 427 includes a web browser and/or some other application for communicating with, navigating, controlling, configuring, and/or using the account management apparatus 430 and/or other portions of the system 400. For example, in some embodiments, the holder 415 uses the browser application 427 to trigger and/or configure one or more aspects of the account management apparatus 430 that relate to making overage determinations and/or offsetting funds transfers. For example, in some embodiments, the holder 415 uses the browser application 427 to select one or more accounts (e.g., the source account 431 and the credit account 433, etc.) for linking. As another example, in some embodiments, the holder 415 uses the browser application 417 to view a notification regarding an overage received from the account management apparatus 430, and/or to transmit a response to that notification to the account management apparatus 430. It will be understood that, in some embodiments, the holder 415 uses the browser application 427 to access an online and/or mobile banking account (not shown) for configuring one or more aspects of the account management apparatus 430. In some embodiments, the browser application 427 includes computer-executable program code portions for instructing the processor 424 to perform one or more of the functions of the browser application 427 described and/or contemplated herein. In some embodiments, the browser application 427 may include and/or use one or more network and/or system communication protocols.

Also shown in FIG. 4 is the user interface 429. In some embodiments, the user interface 429 includes one or more user output devices, such as a display and/or speaker, for presenting information to the holder 415 and/or some other user. In some embodiments, the user interface 429 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the holder 415 and/or some other user. In some embodiments, the user interface 429 includes the input and display devices of a personal computer, such as a keyboard and monitor, that are operable to receive and display information associated with offsetting a liability and/or accumulating rewards.

FIG. 4 also illustrates an account management apparatus 430, in accordance with an embodiment of the present invention. The account management apparatus 430 may include any computerized apparatus that can be configured to perform any one or more of the functions of the account management apparatus 430 described and/or contemplated herein. In accordance with some embodiments, for example, the account management apparatus 430 may include an engine, a platform, a server, a database system, a front end system, a back end system, a personal computer system, and/or the like. In some embodiments, such as the one illustrated in FIG. 4, the account management apparatus 430 includes a communication interface 432, a processor 434, and a memory 436, which includes an account application 437 and an account datastore 438 stored therein. As shown, the communication interface 432 is operatively and selectively connected to the processor 434, which is operatively and selectively connected to the memory 436.

It will be understood that the account application 437 can be configured to implement any one or more portions of any one or more of the process flows described and/or contemplated herein. For example, in some embodiments, the account application 437 is configured to link the source account 431 to the credit account 433. As another example, in some embodiments, the account application 437 is configured to determine that the credit account 431 has incurred, or will incur, an overage as a result of a transaction. As still another example, in some embodiments, the account application 437 is configured to transfer funds from the source account 431 to the credit account 433 in an amount sufficient to offset an overage incurred, or that will be incurred, by the credit account 433 as a result of an over limit transaction. As a further example, in some embodiments, the account application 437 is configured to charge a service fee to the source account 431 and/or the credit account 433. As other examples, in some embodiments, the account application 437 is configured to: (a) receive a request to authorize a transaction involving the credit account 433, (b) determine that the credit account 433 will incur an overage as a result of the transaction, and/or (c) authorize the transaction based at least partially on a determination that the credit account 433 has over limit protection through the source account 431. As still another example, in some embodiments, the account application 437 is additionally or alternatively configured to: (a) generate a notification regarding the overage (e.g., a notification that prompts the holder to authorize or decline the transaction and/or to choose a source account to use in offsetting the overage, etc.); (b) transmit the notification to a device accessible to the holder 415 (e.g., the user interface apparatus 420, etc.) while the transaction is still pending; (c) receive a response to the notification (e.g., from the holder via the user interface apparatus 420, etc.); and (d) authorize the transaction based at least partially on the response.

It will also be understood that, in some embodiments, the account application 437 is additionally configured to provide other kinds of financial services. For example, in some embodiments, the account application 437 may be operable to process financial transactions involving the source account 431 and/or the credit account 433. In some cases, this function is performed alongside one or more of the portions described and/or contemplated herein that relate to receiving authorization requests, making overage determinations, determining authorization decisions, transferring offsetting funds, and/or charging service fees. For example, where the holder 415 initiates a purchase transaction using the credit account 433 at the point of sale device 440, the account application 437 may be configured to authorize the purchase transaction, as well as simultaneously (or sometime thereafter) determine that the credit account 433 has incurred, or will incur, an overage as a result of the purchase transaction, and/or transfer offsetting funds from the source account 431 to the credit account 433. As another example, in some embodiments, the account application 437 is configured to provide online and/or mobile banking services to the holder 415 at the user interface apparatus 420, such as, for example, any of the online and/or mobile banking services described and/or contemplated herein.

It will also be understood that, in some embodiments, the account application 437 is configured to communicate with the account datastore 438, the user interface apparatus 420, the point of sale device 440, and/or any one or more other portions of the system 400. For example, in some embodiments, the account application 437 is configured to receive transaction information from and/or send authorization information to the point of sale device 440. As another example, in some embodiments, the account application 437 is configured to create and/or send one or more notifications to the holder 415 at the user interface apparatus 420 that explain, for example, that the credit account 433 has incurred an overage, and/or that offsetting funds have been transferred from the source account 431 to the credit account 433. It will be further understood that, in some embodiments, the account application 437 includes computer-executable program code portions for instructing the processor 434 to perform any one or more of the functions of the account application 437 described and/or contemplated herein. In some embodiments, the account application 437 may include and/or use one or more network and/or system communication protocols.

In addition to the account application 437, the memory 436 also includes the account datastore 438. In some embodiments, the account datastore 438 includes information associated with one or more financial accounts (e.g., the source account 431, the credit account 433, one or more non-financial institution accounts (not shown), etc.), including, for example, account names, persons and/or entities associated with the financial accounts, addresses associated with the financial accounts, transaction data and/or transaction history associated with the financial accounts, whether one or more financial account are linked to one or more other financial accounts, and/or any other type and/or amount of information. In some embodiments, the account datastore 438 may also store any information relating to providing over limit protection and/or for determining authorization decisions for over limit transactions. For example, in some embodiments, the account datastore 438 stores information associated with whether a credit account has over limit protection through a source account and/or whether a holder of a credit account has opted in to an over limit service provided by a creditor associated with the credit account. In some embodiments, the account datastore 438 additionally or alternatively stores information associated with online and/or mobile banking.

It will be understood that the account datastore 438 may include any one or more storage devices, including, but not limited to, datastores, databases, and/or any of the other storage devices typically associated with a computer system. It will also be understood that the account datastore 438 may store information in any known way, such as, for example, by using one or more computer codes and/or languages, alphanumeric character strings, data sets, figures, tables, charts, links, documents, and/or the like. Further, in some embodiments, the account datastore 438 may include information associated with one or more applications, such as, for example, the account application 437. It will also be understood that, in some embodiments, the account datastore 438 provides a substantially real-time representation of the information stored therein, so that, for example, when the processor 434 accesses the account datastore 438, the information stored therein is current or substantially current.

It will be understood that the embodiment illustrated in FIG. 4 is exemplary and that other embodiments may vary. For example, in some embodiments, some or all of the portions of the system 400 may be combined into a single portion. Specifically, in some embodiments, the user interface apparatus 420 and the account management apparatus 430 are combined into a single user interface and account management apparatus configured to perform all of the same functions of those separate portions as described and/or contemplated herein. Likewise, in some embodiments, some or all of the portions of the system 400 may be separated into two or more distinct portions. Specifically, in some embodiments, the account management apparatus 430 may be separated into a transaction authorization system configured to determine one or more authorization decisions, and an over limit protection apparatus configured to configure set up over limit protection for the credit account 433 through the source account 431, transfer offsetting funds from the source account 431 to the credit account 433, and/or charge service fees to the source account 431 and/or the credit account 433.

In addition, the various portions of the system 400 may be maintained for by the same or separate parties. For example, as previously mentioned, a single financial institution may maintain the source account 431 and the credit account 433, as well as the account management apparatus 430. However, in other embodiments, the accounts and/or the account management apparatus 430 may each be maintained by separate entities.

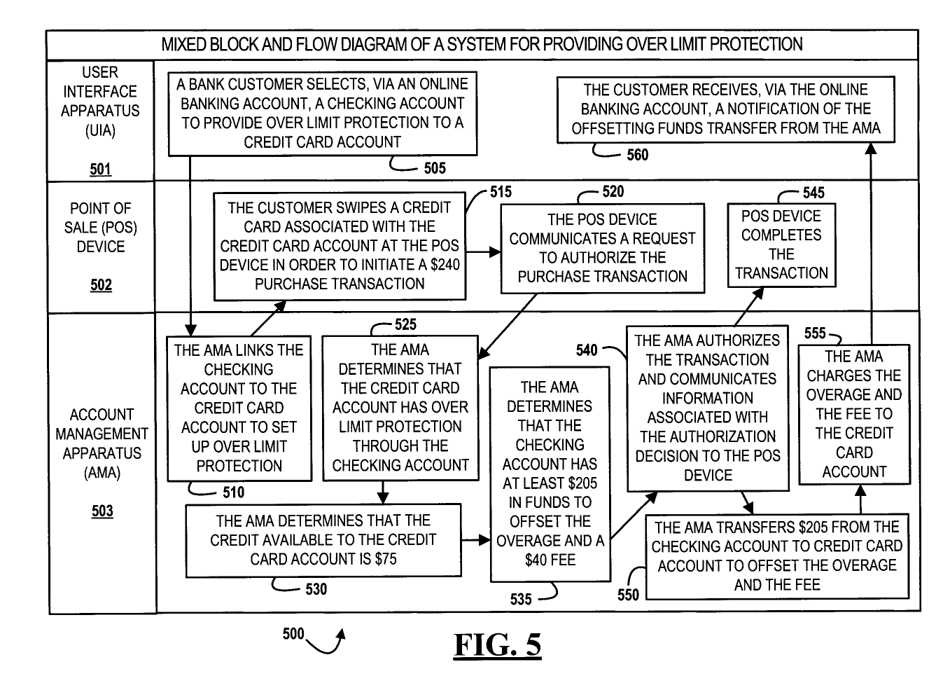

It will also be understood that the system 400 may include and/or implement any one or more portions of any embodiment of the present invention described and/or contemplated herein. More specifically, in some embodiments, the system 400 is configured to implement any one or more portions of the embodiments of the process flow 100 described and/or contemplated herein in connection with FIG. 1, any one or more portions of the embodiments of the process flow 200 described and/or contemplated herein in connection with FIG. 2, any one or more portions of the embodiments of the process flow 300 described and/or contemplated herein in connection with FIG. 3, and/or any one or more portions of the embodiments of the process flow 500 described and/or contemplated herein in connection with FIG. 5.

For example, in some embodiments, the account application 437 is configured to cause the processor 434 of the account management apparatus 430 to: (a) link the source account 431 to the credit account 433, as represented by the block 110 in FIG. 1; (b) determine that the credit account 433 has incurred, or will incur, an overage as a result of a transaction (e.g., performed at the POS device 440, etc.), as represented by the block 120; (c) transfer funds from the source account 431 to the credit account 433 in an amount sufficient to offset the overage, as represented by the block 130; and (d) charge a service fee (e.g., to the source account 431 and/or the credit account 433, etc.), as represented by the block 140. As another example, in some embodiments, the account application 437 is additionally or alternatively configured to cause the processor 434 to: (a) receive a request to authorize a transaction (e.g., the transaction referred to the immediately preceding example, etc.) involving the credit account 433, as represented by the block 210 in FIG. 2; (b) determine that the credit account 433 will incur an overage as a result of the transaction, as represented by the block 220; and (c) authorize the transaction based at least partially on a determination that the credit account 433 has over limit protection through the source account 431, as represented by the block 230.

Referring now to FIG. 5, a mixed block and flow diagram of a system 500 for providing over limit protection is provided, in accordance with a more-detailed embodiment of the present invention. As shown, the system 500 includes a user interface apparatus 501 (e.g., the user interface apparatus 420 in FIG. 4, etc.), a point of sale device 502 (e.g., the point of sale device 440 in FIG. 4, etc.), and an account management apparatus 503 (e.g., the account management apparatus 430 in FIG. 4, etc.). It will be understood that the user interface apparatus 501 and the point of sale device 502 are both operatively and selectively connected to the account management apparatus 503 via a network (not shown). It will also be understood that the user interface apparatus 501 and the point of sale device 502 are accessible to a bank customer (not shown), and that the bank customer holds a checking account and a credit card account that are maintained by the bank (not shown). It will further be understood that the bank provides the customer with access to an online banking account (not shown) for managing and/or otherwise accessing the customer's bank and/or non-bank accounts.

As represented by the block 505, the bank customer selects, via the online banking account, the checking account to provide over limit protection to the credit card account. As represented by the block 510, the account management apparatus 503 is configured to then link the checking account to the credit card account in order to set up over limit protection for the credit card account through the source account. As represented by the block 515, the customer then swipes a credit card associated with the credit card account at the point of sale device 502 in order to initiate a $240 purchase transaction. As represented by the block 520, the point of sale device 502 then communicates a request to authorize the purchase transaction to the account management apparatus 503.

Upon receiving the request, the account management apparatus 503 is configured to determine that the credit card account has over limit protection through the checking account, as represented by the block 525. Then, as represented by the block 530, the account management apparatus 503 is configured to determine that the credit available to the credit card account is $75, and then, as represented by the block 535, the account management apparatus 503 is configured to determine that the checking account has at least $205 in funds to offset the overage and offset a $40 over limit protection fee (i.e., $75−$240=−$165→−$165−$40=−$205→−$205+$205=$0). (It will be understood that these particular numbers are being used by way of example and are in no way limiting on the scope of the present invention.) Thereafter, as represented by the block 540, the account management apparatus 503 is configured to authorize the transaction based at least partially on the determinations represented by the blocks 525 and 530, and then communicate information associated with the authorization decision to the point of sale device 502.

Upon receiving the information associated with the authorization decision, the point of sale device 502 completes the transaction, as represented by the block 545. In addition, after the account management apparatus 503 authorizes the transaction, the account management apparatus 503 is configured to transfer $205 from the checking account to the credit card account in order to offset the overage and the over limit protection fee, as represented by the block 550. Thereafter, the account management apparatus 503 is configured to charge the overage and the over limit protection fee to the credit card account, as represented by the block 555, and then send a notification, via the online banking account, to the bank customer regarding the offsetting funds transfer, as represented by the block 560.

It will be understood that, in accordance with some embodiments, the account management apparatus 503 is configured to perform each of the portions 525-555 in substantially real time while the transaction is pending. It will also be understood that, in accordance with some embodiments, the account management apparatus 503 can be configured to perform each of the portions 525-555 simultaneously, nearly simultaneously, and/or one after the other.

It will further be understood that one or more of the portions of the process flow represented by the blocks 505-560 may be automatically triggered by one or more of the other portions represented by the blocks 505-560. It will also be understood that the embodiment illustrated in FIG. 5 and described herein represents a more-detailed embodiment of the present invention and that other embodiments of the present invention may vary. For example, other embodiments of the present invention may include more, fewer, and/or different types of apparatuses and/or devices. In addition, it will be understood that the order, the number, and/or the content of the portions described in FIG. 5 may be different in other embodiments. It will also be understood that the system 500 may, where possible, include and/or implement any other embodiment of the present invention as described and/or contemplated herein. Likewise, any other embodiment of the present invention described and/or contemplated herein may, where possible, be configured to implement one or more of the portions 505-560.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus comprising:
a communication interface configured to receive a request to authorize a transaction involving a credit account; and
a processor operatively connected to the communication interface and configured to:
determine that the credit account will incur an overage as a result of the transaction; and
authorize the transaction based at least partially on a determination that the credit account comprises over limit protection through a source account.

2. The apparatus of claim 1, wherein the overage comprises the difference between an amount of one or more liabilities incurred by the credit account as a result of the transaction and an amount of credit available to the credit account immediately prior to the transaction.

3. The apparatus of claim 1, wherein the source account comprises two or more source accounts, and wherein the processor is configured to transfer funds from the two or more source accounts to the credit account in accordance with one or more user selections.

4. The apparatus of claim 1, wherein the processor is further configured to transfer funds from the source account to the credit account in an amount sufficient to offset the overage.

5. The apparatus of claim 4, wherein the processor is configured to transfer the funds from the source account to the credit account before the overage is charged to the credit account.

6. The apparatus of claim 1, wherein the processor is configured to authorize the transaction based at least partially on: (a) the determination that the credit account comprises over limit protection through the source account, and (b) a determination that the source account comprises sufficient funds to offset the overage.

7. The apparatus of claim 1, wherein the processor is configured to authorize the transaction based at least partially on: (a) the determination that the credit account comprises over limit protection through the source account, (b) a determination that the source account comprises insufficient funds to offset the overage, and (c) a determination that a holder of the credit account has opted in to an over limit service provided by a creditor associated with the credit account.

8. The apparatus of claim 7, wherein the determination that the holder of the credit account has opted in to the over limit service is based at least partially on the determination that the credit account comprises over limit protection through the source account.

9. The apparatus of claim 7, wherein the over limit service is provided in accordance with the CARD Act.

10. The apparatus of claim 1, wherein the processor is further configured to charge a service fee to at least one of the source account or the credit account.

11. The apparatus of claim 1, wherein the processor is configured to authorize the transaction based at least partially on: (a) the determination that the credit account comprises over limit protection through the source account, and (b) a determination that the amount of the overage is less than a predetermined amount.

12. The apparatus of claim 1, wherein the communication interface is further configured to receive a second request to authorize a second transaction involving a second credit account, and wherein the processor is further configured to:
determine that the second credit account will incur a second overage as a result of the second transaction; and
decline the second transaction based at least partially on: (a) a determination that the second credit account comprises over limit protection through a second source account, (b) a determination that the second source account comprises insufficient funds to offset the second overage, and (c) a determination that a second holder of the second credit account has not opted in to an over limit service provided by a second creditor associated with the second credit account.

13. The apparatus of claim 1, wherein the communication interface is further configured to receive a second request to authorize a second transaction involving a second credit account, and wherein the processor is further configured to:
determine that the second credit account will incur a second overage as a result of the second transaction;
determine that the second credit account comprises over limit protection through a second source account; and
decline the second transaction based at least partially on at least one of: (a) a determination that the amount of the second overage is greater than a predetermined amount, or (b) a determination that the second transaction occurs outside of a predetermined geographic area.

14. The apparatus of claim 1, wherein the communication interface is further configured to receive a second request to authorize a second transaction involving a second credit account, and wherein the processor is further configured to:
determine that the second credit account will incur a second overage as a result of the second transaction;
determine that the second credit account comprises over limit protection through a second source account; and
decline the second transaction based at least partially on a user-selected parameter.

15. The apparatus of claim 1, wherein the processor is further configured to generate a notification regarding the overage, wherein the communication device is further configured to transmit the notification to a device accessible to the consumer while the transaction is still pending, wherein the communication device is further configured to receive a response to the notification, and wherein the processor is further configured to authorize the transaction based at least partially on the response.

16. A method comprising:
receiving a request to authorize a transaction involving a credit account;
determining that the credit account will incur an overage as a result of the transaction; and
authorizing, using a processor, the transaction based at least partially on a determination that the credit account comprises over limit protection through a source account.

17. The method of claim 16, further comprising:
transferring funds from the source account to the credit account in an amount sufficient to offset the overage.

18. The method of claim 16, wherein authorizing the transaction further comprises authorizing the transaction based at least partially on: (a) the determination that the credit account comprises over limit protection through the source account, (b) a determination that the source account comprises insufficient funds to offset the overage, and (c) a determination that a holder of the credit account has opted in to an over limit service provided by a creditor associated with the credit account.

19. The method of claim 18, wherein the determination that the holder of the credit account has opted in to the over limit service is based at least partially on the determination that the credit account comprises over limit protection through the source account.

20. The method of claim 16, further comprising:
charging a service fee to at least one of the source account or the credit account.

21. The method of claim 16, further comprising:
generating, using a processor, a notification regarding the overage;
transmitting the notification to a device accessible to the consumer while the transaction is still pending; and
receiving a response to the notification,
wherein authorizing the transaction further comprises authorizing the transaction based at least partially on the response.

22. An apparatus comprising:
a communication interface configured to receive requests to authorize transactions, wherein each of the transactions involves a credit account that will incur an overage if the transaction is authorized; and
a processor operatively connected to the communication interface and configured to:
authorize a first group of the transactions based at least partially on a determination that, for each transaction in the first group, the credit account comprises over limit protection through a source account;
authorize a second group of the transactions based at least partially on a determination that, for each transaction in the second group, the credit account is held by a holder that has opted in to an over limit service provided by a creditor associated with the credit account; and
decline a third group of the transactions based at least partially on: (a) a determination that, for each transaction in the third group, the credit account does not comprise over limit protection through a source account, and (b) a determination that, for each transaction in the third group, the credit account is held by a holder that has not opted in to an over limit service provided by a creditor associated with the credit account.

23. The apparatus of claim 22, wherein the processor is further configured to:
for each transaction in the first group, transfer funds from the source account to the credit account in an amount sufficient to offset the overage.

24. The apparatus of claim 22, wherein the processor is further configured to:
for each transaction in the first group, charge an over limit protection fee to at least one of the source account or the credit account; and
for each transaction in the second group, charge an overage fee to the credit account, and
wherein the overage fee is greater than the over limit protection fee.

25. The apparatus of claim 22, wherein the processor is configured to authorize the first group of the transactions based at least partially on: (a) the determination that, for each transaction in the first group, the credit account comprises over limit protection through a source account, and (b) a determination that, for each transaction in the first group, the source account comprises sufficient funds to offset the overage.

26. The apparatus of claim 22, wherein the processor is configured to authorize the second group of the transactions based at least partially on: (a) the determination that, for each transaction in the second group, the credit account is held by a holder that has opted in to an over limit service provided by a creditor associated with the credit account, (b) a determination that, for each transaction in the second group, the credit account comprises over limit protection through a source account, and (c) a determination that, for each transaction in the second group, the source account comprises insufficient funds to offset the overage.

27. The apparatus of claim 26, wherein the determination that, for each transaction in the second group, the credit account is held by a holder that has opted in to a over limit service is based at least partially on the determination that, for each transaction in the second group, the credit account comprises over limit protection through a source account.

28. The apparatus of claim 22, wherein the over limit service is provided in accordance with the CARD Act.

29. The apparatus of claim 22, wherein the processor is further configured to:
decline a fourth group of the transactions based at least partially on: (a) a determination that, for each transaction in the fourth group, the credit account comprises over limit protection through a source account, (b) a determination that, for each transaction in the fourth group, the source account comprises insufficient funds to offset the overage, and (c) a determination that, for each transaction in the fourth group, the credit account is held by a holder that has not opted in to an over limit service provided by a creditor associated with the credit account.

30. A method comprising:
receiving requests to authorize transactions, wherein each of the transactions involves a credit account that will incur an overage if the transaction is authorized;
authorizing, using a processor, a first group of the transactions based at least partially on a determination that, for each transaction in the first group, the credit account comprises over limit protection through a source account
authorizing, using a processor, a second group of the transactions based at least partially on a determination that, for each transaction in the second group, the credit account is held by a holder that has opted in to an over limit service provided by a creditor associated with the credit account; and
declining, using a processor, a third group of the transactions based at least partially on: (a) a determination that, for each transaction in the third group, the credit account does not comprise over limit protection through a source account, and (b) a determination that, for each transaction in the third group, the credit account is held by a holder that has not opted in to an over limit service provided by a creditor associated with the credit account.

31. The method of claim 30, further comprising:
for each transaction in the first group, transferring funds from the source account to the credit account in an amount sufficient to offset the overage.

32. The method of claim 30, further comprising:
for each transaction in the first group, charging an over limit protection fee to at least one of the source account or the credit account; and
for each transaction in the second group, charging an overage fee to the credit account,
wherein the overage fee is greater than the over limit protection fee.

33. The method of claim 30, wherein authorizing the first group of the transactions comprises authorizing the first group of the transactions based at least partially on: (a) the determination that, for each transaction in the first group, the credit account comprises over limit protection through a source account, and (b) a determination that, for each transaction in the first group, the source account comprises sufficient funds to offset the overage.

34. The method of claim 30, wherein authorizing the second group of the transactions comprises authorizing the second group of the transactions based at least partially on: (a) the determination that, for each transaction in the second group, the credit account is held by a holder that has opted in to an over limit service provided by a creditor associated with the credit account, (b) a determination that, for each transaction in the second group, the credit account comprises over limit protection through a source account, and (c) a determination that, for each transaction in the second group, the source account comprises insufficient funds to offset the overage.

35. The method of claim 34, wherein the determination that, for each transaction in the second group, the credit account is held by a holder that has opted in to a over limit service is based at least partially on the determination that, for each transaction in the second group, the credit account comprises over limit protection through a source account.

36. The method of claim 30, further comprising:
declining a fourth group of the transactions based at least partially on: (a) a determination that, for each transaction in the fourth group, the credit account comprises over limit protection through a source account, (b) a determination that, for each transaction in the fourth group, the source account comprises insufficient funds to offset the overage, and (c) a determination that, for each transaction in the fourth group, the credit account is held by a holder that has not opted in to an over limit service provided by a creditor associated with the credit account.

37. A computer program product comprising a non-transitory computer-readable medium, wherein the computer-readable medium comprises computer-executable program code portions stored therein, wherein the computer-executable program code portions comprise:
a first program code portion configured to receive requests to authorize transactions, wherein each of the transactions involves a credit account that will incur an overage if the transaction is authorized;
a second program code portion configured to authorize a first group of the transactions based at least partially on a determination that, for each transaction in the first group, the credit account comprises over limit protection through a source account
a third program code portion configured to authorize a second group of the transactions based at least partially on a determination that, for each transaction in the second group, the credit account is held by a holder that has opted in to an over limit service provided by a creditor associated with the credit account; and
a fourth program code portion configured to decline a third group of the transactions based at least partially on a determination that, for each transaction in the third group, the credit account: (a) does not comprise over limit protection through a source account, and (b) is held by a holder that has not opted in to an over limit service provided by a creditor associated with the credit account.

38. The computer program product of claim 37, further comprising:
a fifth program code portion configured to, for each transaction in the first group, transfer funds from the source account to the credit account in an amount sufficient to offset the overage.

39. The computer program product of claim 37, further comprising:
a fifth program code portion configured to, for each transaction in the first group, charge an over limit protection fee to at least one of the source account or the credit account; and
a sixth program code portion configured to, for each transaction in the second group, charge an overage fee to the credit account,
wherein the overage fee is greater than the over limit protection fee.

40. An apparatus comprising:
a processor configured to:
determine that a credit account has incurred, or will incur, an overage as a result of a transaction; and
transfer funds from a source account to the credit account in an amount sufficient to offset the overage.

41. The apparatus of claim 40, wherein the processor is further configured to charge a service fee to at least one of the source account or the credit account.

42. The apparatus of claim 40, further comprising:
a communication interface configured to receive a request to authorize the transaction,
wherein the processor is further configured to authorize the transaction based at least partially on a determination that the credit account comprises over limit protection through the source account.

43. A method comprising:
determining that a credit account has incurred, or will incur, an overage as a result of a transaction; and
transferring funds, using a processor, from a source account to the credit account in an amount sufficient to offset the overage.

44. The method of claim 43, further comprising:
charging a service fee to at least one of the source account or the credit account.

45. The method of claim 43, further comprising:
receiving a request to authorize the transaction; and
authorizing the transaction based at least partially on a determination that the credit account comprises over limit protection through the source account.
